(19) United States
(12) Patent Application Publication
(10) Pub. No.: US 2026/0061837 A1
(43) Pub. Date: Mar. 5, 2026

(54) VEHICLE CONTROL SYSTEM AND VEHICLE CONTROL METHOD

(71) Applicant: Mazda Motor Corporation, Aki-gun (JP)

(72) Inventors: Hironori Fujinaka, Aki-gun (JP); Atsushi Yagi, Aki-gun (JP); Yoshimitsu Fukuda, Aki-gun (JP); Yuichiro Akiya, Aki-gun (JP); Jiahao Li, Aki-gun (JP)

(21) Appl. No.: 19/299,575

(22) Filed: Aug. 14, 2025

(30) Foreign Application Priority Data
Sep. 5, 2024 (JP) 2024-153036

(51) Int. Cl. B60K 28/02

(52) U.S. Cl. CPC B60K 28/02

(57) ABSTRACT

A vehicle control system includes a drive source, an accelerator opening degree sensor that detects an accelerator opening degree, and a control device that controls the drive source based on the accelerator opening degree. The control device obtains a first target acceleration corresponding to the accelerator opening degree and obtains a second target acceleration greater than the first target acceleration, controls the torque of the drive source based on the first or second target accelerations, adjusts the second target acceleration to gradually converge to the first target acceleration based on the first target acceleration and a rate of change of the accelerator opening degree when the rate of change has decreased by a predetermined value or more from an increasing state during control of the torque of the drive source based on the second target acceleration, and controls the torque of the drive source based on the second target acceleration.

### TECHNICAL FIELD

The present disclosure relates to a vehicle control system and a vehicle control method that set a target acceleration and control the torque of a drive source based on the target acceleration.

### BACKGROUND ART

Conventionally, a technique that sets a target acceleration based on an accelerator operation of a driver or the like and controls the torque of a drive source such as an engine or a motor so that this target acceleration is achieved has been known. For example, a technique that improves acceleration response by performing a correction to increase a target acceleration corresponding to an accelerator opening degree during acceleration of a vehicle is known (Japanese Patent Laid-Open No. 2011-148342). In particular, Japanese Patent Laid-Open No. 2011-148342 describes increasing the target acceleration by applying a predetermined gain when the operating speed of an accelerator pedal is greater than or equal to a predetermined value.

In addition to this, a technique related to the present disclosure is described in, for example, Japanese Patent Laid-Open No. 2006-132463. Japanese Patent Laid-Open No. 2006-132463 describes obtaining two target accelerations (the future target acceleration and the immediate target acceleration) based on each of the accelerator opening degree and the rate of change of the target acceleration, and, in adopting one of the target accelerations (the smaller one), smoothly changing the target acceleration to the other target acceleration (the larger one). This accelerates the vehicle while reducing an uncomfortable feeling caused for an occupant.

### SUMMARY

### Technical Problem

As described above, in order to improve the acceleration response, it is effective to perform a control that increases the original target acceleration corresponding to the accelerator opening degree. However, if the target acceleration increased in this manner is continuously used during acceleration, an acceleration greater than expected by the driver may occur, making a driving operation difficult afterward. Thus, it can be considered that it is desirable to return the increased target acceleration to its original target acceleration corresponding to the accelerator opening degree during acceleration. Preferably, it can be considered that it is desirable to cause the increased target acceleration to converge with its original target acceleration without causing the driver to feel uncomfortable.

The present disclosure has been made to solve the problem in the conventional techniques described above, and an object thereof is to provide a vehicle control system and a vehicle control method that can improve acceleration response by increasing a target acceleration and cause the increased target acceleration to converge to its original target acceleration without causing the driver to feel uncomfortable.

### Solution to Problem

In order to achieve the above-mentioned object, the present disclosure provides a vehicle control system including a drive source that generates a driving force of a vehicle, an accelerator opening degree sensor that detects an accelerator opening degree that is an opening degree of an accelerator pedal included in the vehicle, and a control device configured to control the drive source based on the accelerator opening degree detected by the accelerator opening degree sensor. The control device is configured to obtain a first target acceleration that is set in accordance with at least the accelerator opening degree and obtain a second target acceleration that is set greater than at least the first target acceleration, and control a torque of the drive source based on the first target acceleration or the second target acceleration, detect a predetermined condition in which the rate of change of the accelerator opening degree becomes a state in which the rate of change has decreased by a predetermined value or more from an increasing state during control of the torque of the drive source based on the second target acceleration, in response to detecting the predetermined condition, adjust the second target acceleration such that the second target acceleration gradually converges to the first target acceleration based on the first target acceleration and a rate of change of the accelerator opening degree, and control the torque of the drive source based on the second target acceleration.

In this manner, while the acceleration response can be improved by performing acceleration control based on the second target acceleration which is greater than the first target acceleration, when the rate of change of the accelerator opening degree greatly decreases during this acceleration control, by causing the second target acceleration to converge to the first target acceleration, it is possible to prevent the second target acceleration being continuously used from causing the occurrence of an acceleration greater than expected by a driver, making a driving operation difficult afterward. In particular, in the present disclosure, since the second target acceleration is caused to converge to the first target acceleration by taking into consideration the first target acceleration corresponding to the accelerator opening degree and the rate of change of the accelerator opening degree, it is possible to prevent causing the driver to feel uncomfortable during this convergence. From above, according to the present disclosure, it is possible to improve the overall traveling feeling during acceleration.

In the present disclosure, preferably, the control device is configured to determine a convergence speed for causing the second target acceleration to converge to the first target acceleration based on the first target acceleration and the rate of change of the accelerator opening degree, and adjust the second target acceleration based on of the convergence speed.

By adjusting the second target acceleration based on such a convergence speed, it is possible to effectively prevent causing the driver to feel uncomfortable during the convergence of the second target acceleration.

In the present disclosure, preferably, the control device is configured to set the convergence speed higher when the change speed of the accelerator opening degree is a negative value than when the rate of change of the accelerator opening degree is greater than or equal to zero.

In this manner, it is possible to quickly return the second target acceleration to the first target acceleration in accordance with the situation in which the rate of change of the accelerator opening degree is a negative value, that is, the situation in which the accelerator pedal is being eased off.

In the present disclosure, preferably, the control device is configured to set the convergence speed higher when the first target acceleration is decreasing than when the first target acceleration is increasing.

In this manner, it is possible to quickly return the second target acceleration to the first target acceleration in accordance with the situation in which the first target acceleration is decreasing.

In the present disclosure, preferably, the control device is configured to set the convergence speed higher when the change speed of the accelerator opening degree is a positive value and the first target acceleration is decreasing than when the rate of change of the accelerator opening degree is approximately zero.

In this manner, when the first target acceleration is decreasing, it is possible to quickly return the second target acceleration to the first target acceleration by preferentially taking into consideration the first target acceleration over the rate of change of the accelerator opening degree.

In the present disclosure, preferably, the control device is configured to set the convergence speed lower when the change speed of the accelerator opening degree is a positive value and the first target acceleration is increasing than when the rate of change of the accelerator opening degree is approximately zero.

In this manner, when the rate of change of the accelerator opening degree is a positive value and the first target acceleration is increasing, that is, when the vehicle has a strong tendency to accelerate, it is possible to slowly return the second target acceleration to the first target acceleration.

In a preferable example in the present disclosure, the control device is further configured to store a control map in which the convergence speed is defined in relation to the first target acceleration and the rate of change of the accelerator opening degree, and determine, according to the control map, the convergence speed corresponding to the current first target acceleration and the current rate of change of the accelerator opening degree, and adjust the second target acceleration based on the convergence speed.

In the present disclosure, preferably, the control device is configured to finish control of the torque of the drive source based on the second target acceleration when the adjusted second target acceleration reaches the first target acceleration, and start control of the torque of the drive source based on the first target acceleration.

In this manner, it is possible to promptly start normal acceleration control based on the first target acceleration after the convergence of the second target acceleration.

In another aspect, the present disclosure provides a vehicle control method executed by a control device in a vehicle including a drive source that generates a driving force of the vehicle, an accelerator opening degree sensor that detects an accelerator opening degree that is an opening degree of an accelerator pedal included in the vehicle, and the control device configured to control the drive source based on the accelerator opening degree detected by the accelerator opening degree sensor. The method includes obtaining a first target acceleration that is set in accordance with at least the accelerator opening degree and obtaining a second target acceleration that is set greater than at least the first target acceleration, and controlling a torque of the drive source based on the first target acceleration or the second target acceleration, and adjusting the second target acceleration such that the second target acceleration gradually converges to the first target acceleration based on the first target acceleration and a rate of change of the accelerator opening degree when the rate of change of the accelerator opening degree becomes a state in which the rate of change has decreased by a predetermined value or more from an increasing state during control of the torque of the drive source based on the second target acceleration, and controlling the torque of the drive source based on the second target acceleration.

### Advantageous Effects

According to the vehicle control system and the vehicle control method according to the present disclosure, it is possible to improve the acceleration response by increasing the target acceleration and cause the increased target acceleration to converge to its original target acceleration without causing the driver to feel uncomfortable.

### BRIEF DESCRIPTION OF DRAWINGS

FIG. 1 is a schematic configuration diagram of a vehicle to which a vehicle control system according to an embodiment of the present disclosure is applied.

FIG. 2 is an explanatory diagram regarding basic acceleration control using a first target acceleration according to the embodiment of the present disclosure.

FIG. 3 is an explanatory diagram regarding acceleration control using a second target acceleration according to the embodiment of the present disclosure.

FIG. 4 is a flowchart showing acceleration control according to the embodiment of the present disclosure.

FIG. 5 shows a control map of a convergence speed according to the embodiment of the present disclosure.

### DETAILED DESCRIPTION

Hereinbelow, a vehicle control system and a vehicle control method according to an embodiment of the present disclosure will be described with reference to the accompanying drawings.

### Entire Configuration

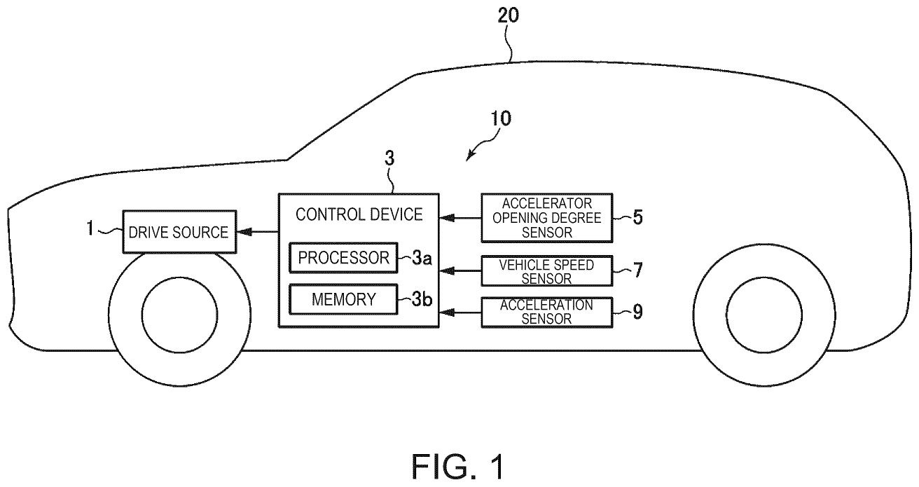

First, the entire configuration of the control system according to the present embodiment will be described with reference to FIG. 1. FIG. 1 is a schematic configuration diagram of a vehicle to which the vehicle control system according to the present embodiment is applied.

As shown in FIG. 1, a vehicle 20 is equipped with a vehicle control system 10 that includes a drive source 1 such as an engine (internal combustion engine) or an electric motor that generates a driving force of the vehicle 20, a control device 3 configured to control the drive source 1, an accelerator opening degree sensor 5 that detects an accelerator opening degree that is the opening degree of an accelerator pedal (not shown) included in the vehicle 20, a vehicle speed sensor 7 that detects the speed of the vehicle 20, and an acceleration sensor 9 that detects the acceleration of the vehicle 20. Note that, in addition to these sensors 5, 7, 9, the vehicle 20 is also provided with various sensors (for example, when the vehicle 20 includes a transmission, a gear stage sensor that detects the gear stage set in the transmission).

The control device 3 is composed of a computer including one or more processors 3a (typically, e.g., central processing units (CPUs)), and memory 3b such as ROM or RAM that stores various programs (including a basic control program such as an operating system (OS) and an application program that is started on the OS to implement a specific function) that are interpreted and executed by the processor 3a, and various data.

In the present embodiment, the control device 3 sets a target acceleration that should be generated by the vehicle based on the accelerator opening degree detected by the accelerator opening degree sensor 5 and the vehicle speed detected by the vehicle speed sensor 7, and controls the torque of the drive source 1 so that the target acceleration is achieved. The details of the control performed by the control device 3 will be described further below.

### Control Method

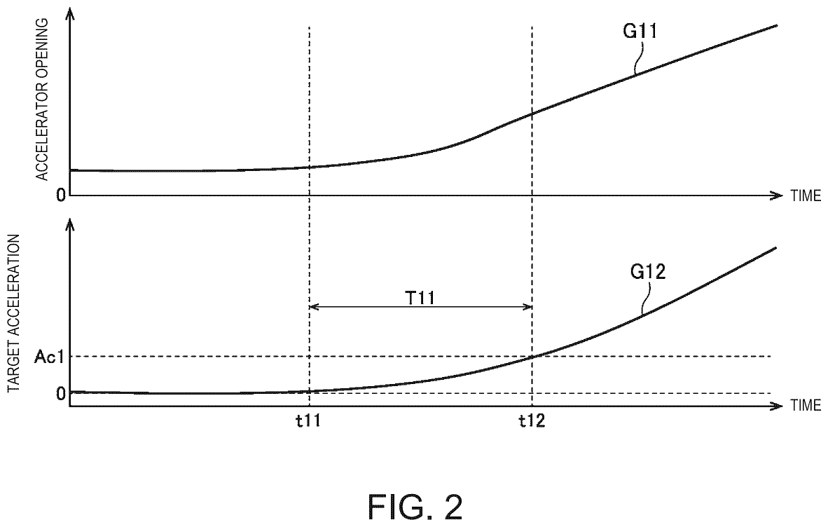

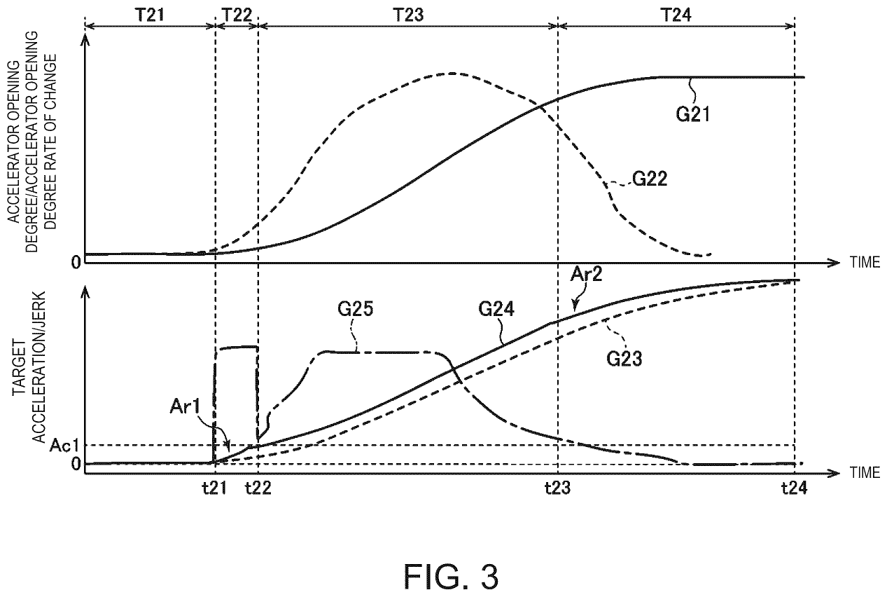

Next, a control method performed by the control device 3 in the present embodiment will be described with reference to FIGS. 2 and 3.

First, a basic acceleration control in the present embodiment will be described with reference to FIG. 2. Graph G11 shows temporal changes in the accelerator opening degree, and graph G12 shows temporal changes in a basic first target acceleration (to be a base) that is set in accordance with this accelerator opening degree.

As shown in FIG. 2, at time t11, during steady traveling of the vehicle 20, the accelerator opening degree is increased by a driver starting to press down on the accelerator pedal (note that “during steady traveling” here means a non-accelerating time in which the vehicle speed is greater than 0 (the same applies thereinafter), and the first target acceleration is basically set to zero). In particular, at time t11, a rate of change of the accelerator opening degree increases by 1% or more. From this time t11, the control device 3 sets the first target acceleration that increases in accordance with the increase in the accelerator opening degree, and controls the torque of the drive source 1 so that this first target acceleration is achieved. In this case, the control device 3 sets the first target acceleration in accordance with the vehicle speed, the gear stage of the transmission included in the vehicle 20, and the like in addition to the accelerator opening degree. For example, the first target acceleration may be set using the method described in Japanese Patent Laid-Open No. 2011-148342 described above.

Incidentally, as described above, at the start of acceleration of the vehicle 20 (when the driver starts to press down on the accelerator pedal), when the acceleration of the vehicle 20 is small, the driver cannot recognize the acceleration. More specifically, when the target acceleration is less than a predetermined acceleration Ac1, the driver cannot recognize the acceleration. This predetermined acceleration Ac1 corresponds to a minimum acceleration (lowest recognizable acceleration) that enables humans to recognize the start of acceleration, and is, for example, an acceleration within the range of 0.27 to 0.3 m/s^{2.}

Here, when the vehicle 20 is accelerated on the basis of the first target acceleration as shown in graph G12 of FIG. 2, since the first target acceleration is less than the predetermined acceleration Ac1 during a period T11 from time t11 to time t12 at the start of acceleration, the driver cannot recognize the acceleration. When such a period T11 is long, the driver tends to feel that the acceleration response is poor.

Thus, in the present embodiment, in order to improve the acceleration response at the start of acceleration, the acceleration of the vehicle 20 is promptly increased to shorten the time when the acceleration of the vehicle 20 is less than the predetermined acceleration Ac1. For this, in the present embodiment, the control device 3 sets a second target acceleration that increases at a rate of change (i.e., slope) greater than the first target acceleration at the start of acceleration. In this case, the control device 3 sets the second target acceleration such that the jerk of the vehicle 20 is increased within a range that does not cause discomfort to the driver, specifically, within a range less than a predetermined jerk of the vehicle 20.

Next, an acceleration control using the second target acceleration according to the present embodiment will be described with reference to FIG. 3. In FIG. 3, graph G21 shows temporal changes in the accelerator opening degree, graph G22 shows temporal changes in the rate of change of the accelerator opening degree, graph G23 shows temporal changes in the first target acceleration, graph G24 shows temporal changes in the second target acceleration, and graph G25 shows temporal changes in the jerk (corresponding to a target jerk) of the vehicle 20.

As shown in FIG. 3, at time t21, during steady traveling of the vehicle 20 (period T21), the rate of change of the accelerator opening degree increases by 1% or more by the driver starting to press down on the accelerator pedal (graph G21). From this time t21, in order to increase the jerk of the vehicle 20 within the range less than the predetermined jerk (graph G25), the control device 3 sets the second target acceleration that increases at the rate of change greater than the first target acceleration (graph G24, arrow Ar1) and controls the torque of the drive source 1 based on the second target acceleration. Note that, when setting the second target acceleration in this manner, the control device 3 also obtains the first target acceleration in parallel with second target acceleration (graph G23). However, at this point, the control device 3 performs the acceleration control based on the second target acceleration (period T22), and does not use the first target acceleration in performing the acceleration control.

Specifically, the control device 3 sets the predetermined jerk described above based on at least any one or more of the rate of increase of the accelerator opening degree, the vehicle speed, the gear stage of the transmission included in the vehicle 20, the rate of change of the first target acceleration, and the gradient of a traveling road of the vehicle 20. Then, the control device 3 sets the second target acceleration so as to increase the jerk of the vehicle 20 within the range less than the predetermined jerk. For example, the control device 3 sets the second target acceleration so as to quickly increase the jerk of the vehicle 20 to the predetermined jerk and maintain the predetermined jerk.

Then, at time t22, the second target acceleration reaches the predetermined acceleration Ac1. The predetermined acceleration Ac1 is set in advance based on the lowest recognizable acceleration described above, and is, for example, an acceleration within the range of 0.27 to 0.3 m/s². From such time t22, the control device 3 finishes increasing the second target acceleration at the rate of change greater than the first target acceleration, sets the second target acceleration such that the second target acceleration is changed at the same rate of change as the first target acceleration while maintaining the difference from the first target acceleration, and controls the torque of the drive source 1 based on the second target acceleration.

Then, at time t23, a predetermined condition occurs in which the rate of change of the accelerator opening degree becomes a state in which the rate of change has decreased by a predetermined value or more from an increasing state, that is, the rate of change of the accelerator opening degree turns from increasing to decreasing by the predetermined value or more (graph G22). After detecting this predetermined condition, from time t23 (period T24), the control device 3 adjusts the second target acceleration such that the second target acceleration gradually converges to the first target acceleration (arrow Ar2), and controls the torque of the drive source 1 based on the second target acceleration. Accordingly, causing the second target acceleration to converge to the first target acceleration prevents the second target acceleration being continuously used from causing the occurrence of an acceleration greater than expected by the driver, making a driving operation difficult afterward. In particular, the control device 3 determines a convergence speed for causing the second target acceleration to converge to the first target acceleration based on the first target acceleration and the rate of change of the accelerator opening degree (the operating speed of the accelerator pedal), and adjusts the second target acceleration based on the convergence speed. More specifically, the control device 3 determines the convergence speed by referring to a control map in which the convergence speed is defined associated with the first target acceleration and the rate of change of the accelerator opening degree. This causes the second target acceleration to converge to the first target acceleration without causing the driver to feel uncomfortable.

Then, at time t24, in response to the adjusted second target acceleration reaching the first target acceleration, that is, in response to the convergence of the second target acceleration to the first target acceleration being completed, the control device 3 finishes the acceleration control based on the second target acceleration and starts the acceleration control based on the first target acceleration.

Note that the control performed from time t21 to time t22 (period T22) is an example of a “second control” in the present disclosure, and the control performed after time t22 is an example of a “first control” in the present disclosure. Although the “first control” is basically the acceleration control using the first target acceleration, the first control also includes the acceleration control using the second target acceleration that is changed at the same rate of change as the first target acceleration, and, on the other hand, the “second control” is the acceleration control using the second target acceleration that is increased at the rate of change greater than the first target acceleration.

### Control Flow

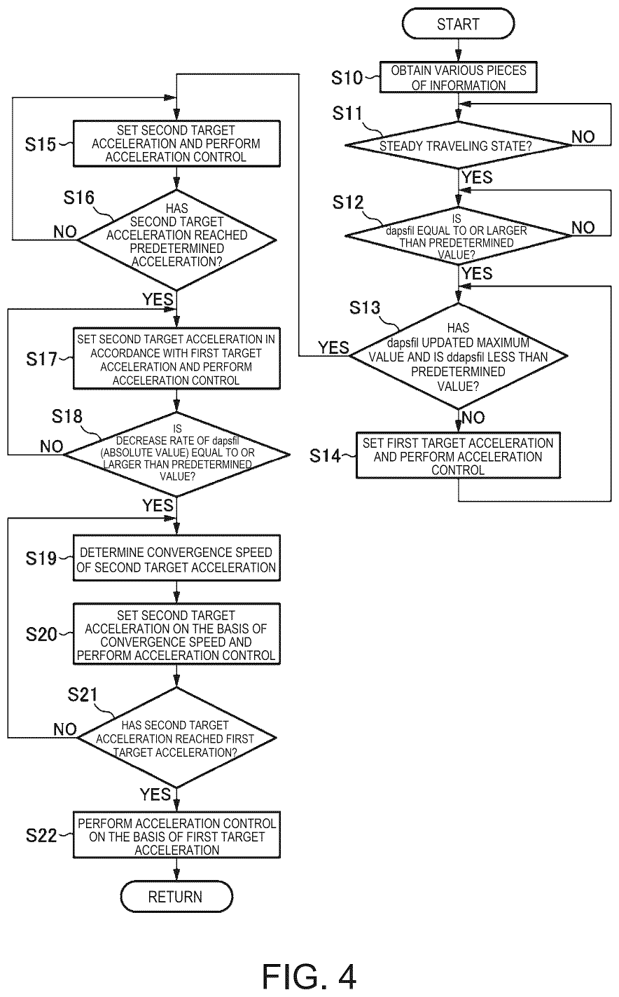

Next, a flowchart showing the acceleration control according to the embodiment of the present disclosure will be described with reference to FIG. 4. This flow is repeatedly executed by the control device 3 at a predetermined cycle. Specifically, the processor 3a in the control device 3 reads a program stored in the memory 3b and executes the program to implement the control related to this flow.

First, in step S10, the control device 3 obtains various pieces of information such as detection values detected by at least the accelerator opening degree sensor 5, the vehicle speed sensor 7, and the acceleration sensor 9. In addition, the control device 3 obtains, from the detection value of the accelerator opening degree sensor 5, an average value of the detection value for 30 ms (corresponding to the accelerator opening degree and referred to as “apsfil” hereinbelow), obtains the slope of the apsfil for 100 ms (corresponding to an accelerator opening degree amount of change and referred to as “dapsfil” hereinbelow), and obtains the slope of the dapsfil for 1 s (referred to as “ddapsfil” hereinbelow).

Next, in step S11, the control device 3 determines whether the vehicle 20 is in a steady traveling state. Specifically, the control device 3 determines that the vehicle 20 is in a steady traveling state when the vehicle speed detected by the vehicle speed sensor 7 is greater than zero (this means that the vehicle 20 is not at a stop) and the acceleration detected by the acceleration sensor 9 (the target acceleration may be used instead of the detected acceleration) is zero (step S11: Yes). In this case, the control device 3 proceeds to step S12.

On the other hand, when the control device 3 does not determine that the vehicle 20 is in a steady traveling state (step S11: No), for example, when the vehicle 20 is at a stop or when the vehicle 20 is already accelerating, the control device 3 does not proceed to step S12. In particular, in the present embodiment, when the vehicle 20 accelerates from a stopped state, the control device 3 does not perform the acceleration control based on the second target acceleration (in this case, the acceleration control based on the first target acceleration is performed). This is because if the acceleration control based on the second target acceleration greatly raises the acceleration from the state in which the vehicle 20 is at a stop, so-called chip-in shock or the like caused by backlash elimination of the transmission may occur.

Next, in step S12, the control device 3 determines whether the dapsfil described above is equal to or greater than a predetermined value. Here, the control device 3 determines whether the rate of change of the accelerator opening degree has increased by 1% or more using the dapsfil. By performing this determination, the acceleration control is performed on the vehicle 20 after the driver's intention to operate the accelerator pedal is confirmed to a certain extent. As a result of step S12, when the control device 3 determines that the dapsfil is equal to or greater than the predetermined value (step S12: Yes), the control device 3 proceeds to step S13. On the other hand, when the control device 3 does not determine that the dapsfil is equal to or greater than the predetermined value (step S12: No), that is, when the dapsfil is less than the predetermined value, the control device 3 returns to step S12 and does not proceed to step S13.

Next, in step S13, the control device 3 determines whether the dapsfil has updated a maximum value and the ddapsfil is less than a predetermined value. Here, first, the driver's acceleration intention (acceleration request) is checked by determining whether the dapsfil (that relatively largely fluctuates) sequentially obtained has updated the maximum value. In addition, by determining whether the ddapsfil is less than the predetermined value, it is checked whether, for example, there is no accelerator operation caused by vibrations of the driver's foot that unintentionally occur due to an impact when the vehicle 20 climbs over a step. In such a situation, since a large acceleration should not be generated in the vehicle 20, the acceleration control based on the second target acceleration is not performed (in this case, the acceleration control based on the first target acceleration is performed).

As a result of step S13, when the control device 3 does not determine that the dapsfil has updated the maximum value and the ddapsfil is less than the predetermined value (step S13: No), the control device 3 proceeds to step S14, sets the first target acceleration, and controls the torque of the drive source 1 so that this first target acceleration is achieved. In this case, the control device 3 sets the first target acceleration in accordance with the accelerator opening degree, the vehicle speed, the gear stage of the transmission, and the like. For example, the control device 3 may set the first target acceleration using the method described in Japanese Patent Laid-Open No. 2011-148342 described above.

On the other hand, as a result of step S13, when the control device 3 determines that the dapsfil has updated the maximum value and the ddapsfil is less than the predetermined value (step S13: Yes), the control device 3 proceeds to step S15, sets the second target acceleration, and controls the torque of the drive source 1 so that this second target acceleration is achieved. Specifically, the control device 3 sets the predetermined jerk based on the ddapsfil (corresponding to the rate of increase of the accelerator opening degree), the vehicle speed, the gear stage of the transmission, the rate of change of the first target acceleration, the gradient of the traveling road of the vehicle 20, and the like, and sets the second target acceleration that increases at the rate of change greater than the first target acceleration in order to increase the jerk of the vehicle 20 within the range less than the predetermined jerk (typically, the second target acceleration is set so as to promptly increase the jerk of the vehicle 20 to the predetermined jerk and maintain this predetermined jerk).

Here, a specific setting method of the second target acceleration by the control device 3 (in particular, a setting method of the predetermined jerk for setting the second target acceleration) will be described as an example. First, when the ddapsfil is large, the control device 3 sets a relatively large predetermined jerk in order to greatly raise the second target acceleration. In this case, the control device 3 preferably use the maximum value of the ddapsfil in order to properly determine the degree of the driver's acceleration intention. In addition, when the vehicle speed is a low speed (approximately 10 to 30 km/h) and when the vehicle speed is a high speed (60 km/h or higher), the control device 3 sets a relatively small predetermined jerk so that the difference between the second target acceleration and the first target acceleration does not increase, and, on the other hand, when the vehicle speed is a medium speed (approximately 30 to 60 km/h), the control device 3 sets a relatively large predetermined jerk in order to greatly raise the second target acceleration. In addition, when the gear stage is a low gear (e.g., first gear), the control device 3 sets a relatively small predetermined jerk in order to reduce shock. In addition, when the rate of change of the first target acceleration is small, a relatively small predetermined jerk is set. This is because if the rate of change of the second target acceleration is increased when the rate of change of the first target acceleration is small, the rate of change of the second target acceleration suddenly decreases when the stage of changing the second target acceleration is started at the rate of change of the first target acceleration (refer to time t22, period T23 in FIG. 3), and the continuity of the acceleration is lost. In addition, when the gradient of the traveling road is large, the control device 3 sets a relatively large predetermined jerk in order to increase the second target acceleration.

Although a plurality of predetermined jerks can be obtained using the various parameters as described above, the control device 3 ultimately adopts the smallest one of the plurality of predetermined jerks obtained and sets the second target acceleration based on this predetermined jerk, for example, sets the second target acceleration with the smallest amount of change. This is to suppress discomfort caused for the driver due to a large jerk and a problem caused by the second target acceleration with a large amount of change and rate of change. Basically, the control device 3 determines, in particular, the slope of the second target acceleration based on such a predetermined jerk.

Next, after step S15 described above, the control device 3 proceeds to step S16, and determines whether the second target acceleration has reached the predetermined acceleration Ac1. As a result, when the control device 3 determines that the second target acceleration has reached the predetermined acceleration Ac1 (step S16: Yes), the control device 3 proceeds to step S17, and, on the other hand, when the control device 3 does not determine that the second target acceleration has reached the predetermined acceleration Ac1 (step S16: No), the control device 3 returns to step S15. In the latter case, the control device 3 continues the acceleration control based on the second target acceleration set in step S15 until the second target acceleration reaches the predetermined acceleration Ac1.

Next, in step S17, the control device 3 finishes increasing the second target acceleration at the rate of change greater than the first target acceleration, sets the second target acceleration such that the second target acceleration is changed at the same rate of change as the first target acceleration while maintaining the difference from the first target acceleration, and controls the torque of the drive source 1 based on the second target acceleration. Then, the control device 3 proceeds to step S18.

Next, in step S18, the control device 3 determines whether the absolute value of a decrease rate (%) of the dapsfil has become equal to or greater than a predetermined value, that is, whether the rate of change of the accelerator opening degree has become a state in which the rate of change has decreased by a predetermine value or more from an increasing state (i.e., the predetermined condition is detected). As a result, when the control device 3 determines that the absolute value of the decrease rate of the dapsfil has become equal to or greater than the predetermined value (step S18: Yes), the control device 3 proceeds to step S19, and, on the other hand, when the control device 3 does not determine that the absolute value of the decrease rate of the dapsfil has become equal to or greater than the predetermined value (step S18: No), the control device 3 returns to step S17. In the latter case, the control device 3 continues the acceleration control based on the second target acceleration set in step S17 until the absolute value of the decrease rate of the dapsfil becomes equal to or greater than the predetermined value.

Next, in step S19 and thereafter, the control device 3 adjusts the second target acceleration such that the second target acceleration gradually converges to the first target acceleration, and controls the torque of the drive source 1 based on the second target acceleration. First, in step S19, the control device 3 determines the convergence speed for causing the second target acceleration to converge to the first target acceleration based on the first target acceleration and the rate of change of the accelerator opening degree (the operating speed of the accelerator pedal). Specifically, the control device 3 determines the convergence speed corresponding to the current first target acceleration and the current rate of change of the accelerator opening degree by referring to the control map in which the convergence speed is defined associated with the first target acceleration and the rate of change of the accelerator opening degree.

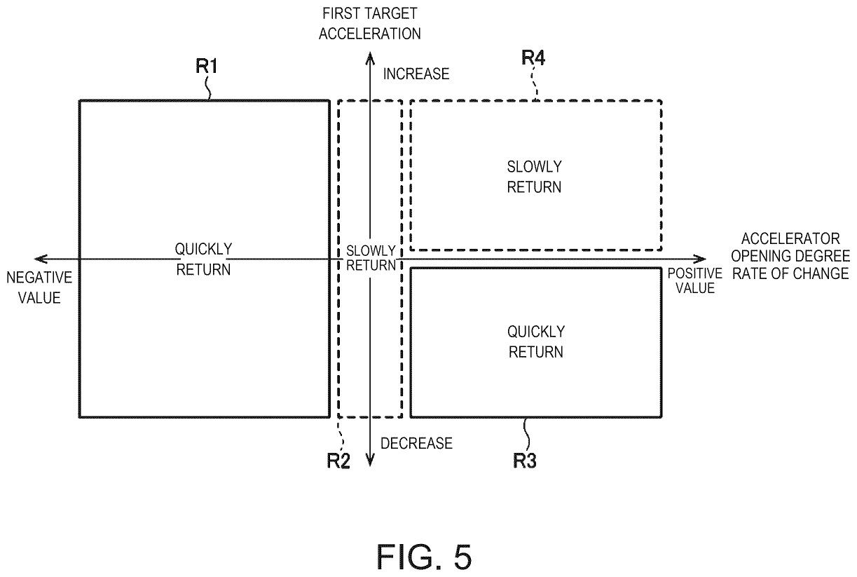

Here, the control map of the convergence speed according to the embodiment of the present disclosure will be described with reference to FIG. 5. The control map defines the convergence speed associated with the rate of change of the accelerator opening degree (horizontal axis) and the first target acceleration (vertical axis). Specifically, the control map includes four regions R1 to R4 that are defined by the rate of change of the accelerator opening degree and the first target acceleration, and the value of the convergence speed to be applied (that means the absolute value) is set for each of these regions R1 to R4. In this case, one convergence speed value is set for each of the four regions R1 to R4. Note that, in FIG. 5, the rate of change of the accelerator opening degree shown on the horizontal axis is defined so as to be a positive value (indicating that the accelerator pedal is being pressed down) on the right side of the center of the horizontal axis (the rate of change is zero) and to be a negative value (indicating that the accelerator pedal is being eased off) on the left side of the center of the horizontal axis. In addition, the first target acceleration shown on the vertical axis is defined so as to increase on the upper side of the center of the vertical axis (the first target acceleration is constant) and to decrease on the lower side of the center of the vertical axis.

The region R1 is the region where the rate of change of the accelerator opening degree is a negative value (that is, the region where the accelerator opening degree is decreasing, in other words, the region where the accelerator pedal is being eased off), and in this region R1, a relatively high convergence speed is set in order to quickly return the second target acceleration to the first target acceleration in accordance with the situation in which the accelerator pedal is being eased off. In addition, the region R2 is the region where the rate of change of the accelerator opening degree is approximately zero (that is, the region where the accelerator opening degree is almost constant, in other words, the region where the position of the accelerator pedal is almost fixed), and in this region R2, a relatively low convergence speed is set in order to slowly return the second target acceleration to the first target acceleration in accordance with the situation in which the accelerator pedal is hardly being operated. Note that the rate of change of the accelerator opening degree being approximately zero means the absolute value of the rate of change being less than a predetermined value close to zero.

In addition, the region R3 is the region where the rate of change of the accelerator opening degree is a positive value and the first target acceleration is decreasing, and in this region R3, a relatively high convergence speed is set in order to quickly return the second target acceleration to the first target acceleration in accordance with the situation in which the first target acceleration is decreasing. In addition, the region R4 is the region where the rate of change of the accelerator opening degree is a positive value and the first target acceleration is increasing, and in this region R4, a relatively low convergence speed is set in order to slowly return the second target acceleration to the first target acceleration in accordance with the situation in which the first target acceleration is increasing.

Next, the relationship between the convergence speeds set in the regions R1 to R4 will be described. First, the convergence speed set in the region R1 is higher than the convergence speeds set in the other regions R2 to R4. Accordingly, a higher convergence speed is set when the rate of change of the accelerator opening degree is a negative value than when the rate of change of the accelerator opening degree is equal to or greater than zero. In addition, the convergence speed set in the region R3 is higher than the convergence speed set in the region R4. Since the regions R3 and R4 are divided based on whether the first target acceleration decrease or increases (note that both the regions R1 and R2 are not defined based on the first target acceleration), it can be said from the relationship between these regions R3 and R4 that a higher convergence speed is set when the first target acceleration is decreasing than when the first target acceleration is increasing.

In addition, the convergence speed set in the region R3 is higher than the convergence speed set in the region R2. Accordingly, a higher convergence speed is set when the rate of change of the accelerator opening degree is a positive value and the first target acceleration is decreasing than when the rate of change of the accelerator opening degree is approximately zero. In addition, the convergence speed set in the region R4 is lower than the convergence speed set in the region R2. Accordingly, a lower convergence speed is set when the rate of change of the accelerator opening degree is a positive value and the first target acceleration is increasing than when the rate of change of the accelerator opening degree is approximately zero.

Note that although, in the example described above, the control map in which one convergence speed value is set for each of the regions R1 to R4 is shown, in another example, a plurality of convergence speed values that change continuously or in stages in accordance with the rate of change of the accelerator opening degree and the magnitude of the first target acceleration may be set in each of the regions R1 to R4. In this case, it is preferable to set the convergence speed higher as the rate of change of the accelerator opening degree decreases, and set the convergence speed higher as the first target acceleration more greatly decreases (in other words, to set the convergence speed lower as the first target acceleration more greatly increases).

Returning to FIG. 4, after step S19 described above, the control device 3 proceeds to step S20, sets the second target acceleration based on the convergence speed determined in step S19, and controls the torque of the drive source 1 based on the second target acceleration. Then, the control device 3 proceeds to step S21, and determines whether the second target acceleration has reached the first target acceleration, that is, whether the convergence of the second target acceleration to the first target acceleration has been completed. As a result, when the control device 3 determines that the second target acceleration has reached the first target acceleration (step S21: Yes), the control device 3 proceeds to step S22. In this case, the control device 3 finishes the acceleration control based on the second target acceleration and starts the acceleration control based on the first target acceleration (step S22). Then, the control device 3 finishes the process shown in the flow of FIG. 4. On the other hand, when the control device 3 does not determine that the second target acceleration has reached the first target acceleration (step S21: No), the control device returns to step S19. In this case, the control device 3 determines the convergence speed until the second target acceleration reaches the first target acceleration, and continues the acceleration control based on the second target acceleration that is set based on the convergence speed.

### Operation and Effects

Next, the operation and effects of the vehicle control system and the vehicle control method according to the present embodiment will be described.

In the present embodiment, the control device 3 obtains the first target acceleration that is set in accordance with at least the accelerator opening degree and obtains the second target acceleration that is set greater than at least the first target acceleration, controls the torque of the drive source 1 based on the first target acceleration or the second target acceleration, detects a predetermined condition in which the rate of change of the accelerator opening degree becomes a state in which the rate of change has decreased by a predetermined value or more from an increasing state during control of the torque of the drive source based on the second target acceleration, in response to detecting the predetermined condition, adjusts the second target acceleration such that the second target acceleration gradually converges to the first target acceleration based on the first target acceleration and the rate of change of the accelerator opening degree, and controls the torque of the drive source 1 based on the second target acceleration.

According to the present embodiment as described above, while the acceleration response can be improved by performing the acceleration control based on the second target acceleration greater than the first target acceleration, when the rate of change of the accelerator opening degree greatly decreases during this acceleration control, by causing the second target acceleration to gradually converge to the first target acceleration, it is possible to prevent the second target acceleration being continuously used from causing the occurrence of an acceleration greater than expected by the driver, making a driving operation difficult afterward. In particular, in the present embodiment, since the second target acceleration is caused to converge to the first target acceleration by taking into consideration the first target acceleration corresponding to the accelerator opening degree and the rate of change of the accelerator opening degree, it is possible to prevent causing the driver to feel uncomfortable during this convergence. From above, according to the present embodiment, it is possible to improve the overall traveling feeling during acceleration.

In addition, in the present embodiment, the control device 3 determines the convergence speed for causing the second target acceleration to converge to the first target acceleration based on the first target acceleration and the rate of change of the accelerator opening degree, and adjusts the second target acceleration based on the convergence speed. By adjusting the second target acceleration based on such a convergence speed, it is possible to effectively prevent causing the driver to feel uncomfortable during the convergence of the second target acceleration.

In addition, in the present embodiment, the control device 3 makes the convergence speed higher when the change speed of the accelerator opening degree is a negative value than when the rate of change of the accelerator opening degree is greater than or equal to zero. Accordingly, it is possible to quickly return the second target acceleration to the first target acceleration in accordance with the situation in which the accelerator pedal is being eased off.

In addition, in the present embodiment, the control device 3 makes the convergence speed higher when the first target acceleration is decreasing than when the first target acceleration is increasing. Accordingly, it is possible to quickly return the second target acceleration to the first target acceleration in accordance with the situation in which the first target acceleration is decreasing.

In addition, in the present embodiment, the control device 3 makes the convergence speed higher larger when the change speed of the accelerator opening degree is a positive value and the first target acceleration is decreasing than when the rate of change of the accelerator opening degree is approximately zero. Accordingly, when the first target acceleration is decreasing, it is possible to quickly return the second target acceleration to the first target acceleration by preferentially taking into consideration the first target acceleration over the rate of change of the accelerator opening degree.

In addition, in the present embodiment, the control device 3 makes the convergence speed lower when the change speed of the accelerator opening degree is a positive value and the first target acceleration is increasing than when the rate of change of the accelerator opening degree is approximately zero. Accordingly, when the rate of change of the accelerator opening degree is a positive value and the first target acceleration is increasing, that is, when the vehicle 20 has a strong tendency to accelerate, it is possible to slowly return the second target acceleration to the first target acceleration.

In addition, in the present embodiment, the control device 3 finishes the control of the torque of the drive source 1 based on the second target acceleration when the adjusted second target acceleration reaches the first target acceleration, and starts the control of the torque of the drive source 1 based on the first target acceleration. Accordingly, it is possible to promptly start normal acceleration control based on the first target acceleration after the convergence of the second target acceleration.

### Modifications

As described above, the embodiment described above is an example to describe the present disclosure, and the present disclosure is not limited to these embodiments. The present disclosure can be implemented in various modes without departing from the gist thereof.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### Reference Character List

1 drive source
3 control device
5 accelerator opening degree sensor
7 vehicle speed sensor
9 acceleration sensor
10 vehicle control system
20 vehicle

1. A vehicle control system comprising:
a drive source that generates a driving force of a vehicle;
an accelerator opening degree sensor that detects an accelerator opening degree that is an opening degree of an accelerator pedal included in the vehicle; and
a control device configured to control the drive source based on the accelerator opening degree detected by the accelerator opening degree sensor, wherein the control device is configured to:
obtain a first target acceleration that is set in accordance with at least the accelerator opening degree and obtain a second target acceleration that is set greater than the first target acceleration, and control a torque of the drive source based on the first target acceleration or the second target acceleration, and
detect a predetermined condition in which the rate of change of the accelerator opening degree becomes a state in which the rate of change has decreased by a predetermined value or more from an increasing state during control of the torque of the drive source based on the second target acceleration,
in response to detecting the predetermined condition, adjust the second target acceleration such that the second target acceleration gradually converges to the first target acceleration based on the first target acceleration and a rate of change of the accelerator opening degree, and
control the torque of the drive source based on the second target acceleration.

2. The vehicle control system according to claim 1, wherein the control device is configured to determine a convergence speed for causing the second target acceleration to converge to the first target acceleration based on the first target acceleration and the rate of change of the accelerator opening degree, and adjust the second target acceleration based on the convergence speed.

3. The vehicle control system according to claim 2, wherein the control device is configured to set the convergence speed higher when the change speed of the accelerator opening degree is a negative value than when the rate of change of the accelerator opening degree is greater than or equal to zero.

4. The vehicle control system according to claim 2, wherein the control device is configured to set the convergence speed higher when the first target acceleration is decreasing than when the first target acceleration is increasing.

5. The vehicle control system according to claim 2, wherein the control device is configured to set the convergence speed higher when the change speed of the accelerator opening degree is a positive value and the first target acceleration is decreasing than when the rate of change of the accelerator opening degree is approximately zero.

6. The vehicle control system according to claim 2, wherein the control device is configured to set the convergence speed lower when the change speed of the accelerator opening degree is a positive value and the first target acceleration is increasing than when the rate of change of the accelerator opening degree is approximately zero.

7. The vehicle control system according to claim 2, wherein the control device is further configured to:
store a control map in which the convergence speed is defined in relation to the first target acceleration and the rate of change of the accelerator opening degree, and
determine, according to the control map, the convergence speed corresponding to the current first target acceleration and the current rate of change of the accelerator opening degree, and adjust the second target acceleration based on the convergence speed.

8. The vehicle control system according to claim 1, wherein the control device is configured to finish control of the torque of the drive source based on the second target acceleration when the adjusted second target acceleration reaches the first target acceleration, and start control of the torque of the drive source based on the first target acceleration.

9. A vehicle control method executed by a control device in a vehicle including a drive source that generates a driving force of the vehicle, an accelerator opening degree sensor that detects an accelerator opening degree that is an opening degree of an accelerator pedal included in the vehicle, and the control device configured to control the drive source based on the accelerator opening degree detected by the accelerator opening degree sensor, the method comprising:
obtaining a first target acceleration that is set in accordance with at least the accelerator opening degree and obtaining a second target acceleration that is set greater than at least the first target acceleration, and controlling a torque of the drive source based on the first target acceleration or the second target acceleration; and
adjusting the second target acceleration such that the second target acceleration gradually converges to the first target acceleration based on the first target acceleration and a rate of change of the accelerator opening degree when the rate of change of the accelerator opening degree becomes a state in which the rate of change has decreased by a predetermined value or more from an increasing state during control of the torque of the drive source based on the second target acceleration, and controlling the torque of the drive source based on the second target acceleration.

10. The vehicle control method according to claim 9, further comprising determining a convergence speed for causing the second target acceleration to converge to the first target acceleration based on the first target acceleration and the rate of change of the accelerator opening degree, and adjusting the second target acceleration based on the convergence speed.

11. The vehicle control method according to claim 10, further comprising setting the convergence speed higher when the change speed of the accelerator opening degree is a negative value than when the rate of change of the accelerator opening degree is greater than or equal to zero.

12. The vehicle control method according to claim 10, further comprising setting the convergence speed higher when the first target acceleration is decreasing than when the first target acceleration is increasing.

13. The vehicle control method according to claim 10, further comprising setting the convergence speed higher when the change speed of the accelerator opening degree is a positive value and the first target acceleration is decreasing than when the rate of change of the accelerator opening degree is approximately zero.

14. The vehicle control method according to claim 10, further comprising setting the convergence speed lower when the change speed of the accelerator opening degree is a positive value and the first target acceleration is increasing than when the rate of change of the accelerator opening degree is approximately zero.

15. The vehicle control method according to claim 10, further comprising:
storing a control map in which the convergence speed is defined in relation to the first target acceleration and the rate of change of the accelerator opening degree; and
determining, according to the control map, the convergence speed corresponding to the current first target acceleration and the current rate of change of the accelerator opening degree, and adjusting the second target acceleration based on the convergence speed.

16. The vehicle control method according to claim 9, further comprising finishing control of the torque of the drive source based on the second target acceleration when the adjusted second target acceleration reaches the first target acceleration, and starting control of the torque of the drive source based on the first target acceleration.

17. A vehicle control system for a vehicle having a drive source that generates a driving force of a vehicle the vehicle including an accelerator opening degree sensor that detects an accelerator opening degree that is an opening degree of an accelerator pedal included in the vehicle, the vehicle control system comprising:
a control device configured to control the drive source based on the accelerator opening degree detected by the accelerator opening degree sensor, wherein the control device is configured to:
obtain a first target acceleration that is set in accordance with at least the accelerator opening degree and obtain a second target acceleration that is set greater than the first target acceleration, and control a torque of the drive source based on the first target acceleration or the second target acceleration,
detect a predetermined condition in which the rate of change of the accelerator opening degree becomes a state in which the rate of change has decreased by a predetermined value or more from an increasing state during control of the torque of the drive source based on the second target acceleration,
in response to detecting the predetermined condition, adjust the second target acceleration such that the second target acceleration gradually converges to the first target acceleration based on the first target acceleration and a rate of change of the accelerator opening degree, and
control the torque of the drive source based on the second target acceleration.

18. The vehicle control system according to claim 17, wherein the control device is configured to determine a convergence speed for causing the second target acceleration to converge to the first target acceleration based on the first target acceleration and the rate of change of the accelerator opening degree, and adjust the second target acceleration based on the convergence speed.

19. The vehicle control system according to claim 18, wherein the control device is configured to set the convergence speed higher when the change speed of the accelerator opening degree is a negative value than when the rate of change of the accelerator opening degree is greater than or equal to zero.

20. The vehicle control system according to claim 17, wherein the control device is configured to set the convergence speed higher when the first target acceleration is decreasing than when the first target acceleration is increasing.
